(19) United States
(12) Patent Application Publication
(10) Pub. No.: US 2024/0098684 A1
(43) Pub. Date: Mar. 21, 2024

(54) FIXED DEVICE, POSITION ESTIMATION SYSTEM, CONTROL CIRCUIT, STORAGE MEDIUM, POSITION ESTIMATION METHOD AND MOBILE DEVICE

(71) Applicant: MITSUBISHI ELECTRIC CORPORATION, Tokyo (JP)

(72) Inventors: Shusaku UMEDA, Tokyo (JP); Akinori TAIRA, Tokyo (JP); Hiroyasu SANO, Tokyo (JP); Mari OCHIAI, Tokyo (JP)

(73) Assignee: MITSUBISHI ELECTRIC CORPORATION, Tokyo (JP)

(21) Appl. No.: 18/519,334

(22) Filed: Nov. 27, 2023

Related U.S. Application Data
(63) Continuation of application No. PCT/JP2021/026484, filed on Jul. 14, 2021.

(51) Int. Cl. H04W 64/00; G01S 5/14

(52) U.S. Cl. CPC H04W 64/003; G01S 5/14

(57) ABSTRACT

A master device that is a fixed device belongs to any of a plurality of areas, and includes: a notification information generation unit that generates notification information including position information of a plurality of fixed devices installed in the area to which the fixed device belongs; and a communication unit that transmits a notification signal including the notification information to a mobile device at a timing different from a timing of transmission of the notification signal from another area, the mobile device being configured to estimate a position based on the notification information.

### CROSS-REFERENCE TO RELATED APPLICATION

This application is a continuation application of International Application PCT/JP2021/026484, filed on Jul. 14, 2021, and designating the U.S., the entire contents of which are incorporated herein by reference.

### BACKGROUND OF THE INVENTION

### 1. Field of the Invention

The present disclosure relates to a fixed device that transmits notification information for use in position estimation, a position estimation system, a control circuit, a storage medium, and a position estimation method, and a mobile device.

### 2. Description of the Related Art

Techniques are available in which the distance between a fixed device fixed on the ground and a mobile device is measured from the propagation time between them using the transmission/reception timing of communication, and the position of the mobile device is estimated using the position of the fixed device and the distance measurement result. Ultra-wide band (UWB) signals are ultra-short pulse signals in the time domain. Therefore, the use of UWB signals makes it possible to grasp the transmission/reception timing of communication with high resolution, and to estimate the position of the mobile device with high accuracy.

In order to achieve highly accurate position estimation in a wide range, it is necessary to increase the number of fixed devices. However, fixed devices normally transmit a notification signal indicating its position information, and in a case where the number of fixed devices increases, the number of notification signals to be transmitted increases when each of the plurality of fixed devices transmits a notification signal. For example, in a case where only one band is available for transmitting notification signals, the notification signals are transmitted in a time division manner so as to avoid collision between the notification signals transmitted by the fixed devices. Therefore, as the number of fixed devices increases, the time taken for transmitting notification signals increases, and the proportion of time available for position estimation decreases. This is problematic in that the frequency of performing the position estimation processing decreases and the accuracy of position estimation decreases.

In order to solve this problem, WO 2020/031550 A1 discloses a positioning system in which one representative of a plurality of fixed devices measures the distance from a mobile device, and the other fixed devices simply receive a signal transmitted from the mobile device to execute positioning using the difference in propagation distance from the representative fixed device. With the positioning system disclosed in WO 2020/031550 A1, the number of executions of communication from the fixed devices to the mobile device can be reduced, and thus the proportion of time available for position estimation can be maintained even in the case where the number of fixed devices increases.

However, the positioning system disclosed in WO 2020/031550 A1 has a problem that positioning is executed by the fixed devices and position estimation cannot be performed in the mobile device.

### SUMMARY OF THE INVENTION

In order to solve the above problem and achieve the object, the fixed device according to the present disclosure belongs to any of a plurality of areas and includes: a notification information generation unit to generate notification information including position information of a plurality of fixed devices installed in the area to which the fixed device belongs; and a communication unit to transmit a notification signal including the notification information to a mobile device at a timing different from a timing of transmission of the notification signal from another area, the mobile device being configured to estimate a position based on the notification information.

### BRIEF DESCRIPTION OF THE DRAWINGS

FIG. 1 is a diagram illustrating a configuration of a position estimation system according to a first embodiment;

FIG. 2 is a diagram illustrating a functional configuration of the master device illustrated in FIG. 1;

FIG. 3 is a diagram illustrating a functional configuration of the mobile terminal illustrated in FIG. 1;

FIG. 4 is a sequence diagram for explaining a communication procedure in the position estimation system illustrated in FIG. 1;

FIG. 5 is a diagram illustrating a configuration of a position estimation system according to a second embodiment;

FIG. 6 is a diagram illustrating a functional configuration of the fixed device illustrated in FIG. 5;

FIG. 7 is a diagram illustrating a functional configuration of a fixed device according to a fourth embodiment;

FIG. 8 is a diagram illustrating a configuration of a position estimation system according to a fifth embodiment;

FIG. 9 is a diagram illustrating a configuration of a position estimation system according to a sixth embodiment;

FIG. 10 is a diagram illustrating a functional configuration of the base station illustrated in FIG. 9;

FIG. 11 is a diagram illustrating a functional configuration of the mobile station illustrated in FIG. 9;

FIG. 12 is a diagram illustrating a configuration of a position estimation system according to a seventh embodiment;

FIG. 13 is a flowchart for explaining a method with which the position estimation system illustrated in FIG. 12 forms areas;

FIG. 14 is a diagram illustrating the position estimation system after execution of step S103 in FIG. 13;

FIG. 15 is a diagram illustrating a first example of the position estimation system after execution of step S105 in FIG. 13;

FIG. 16 is a diagram illustrating a second example of the position estimation system after execution of step S105 in FIG. 13;

FIG. 17 is a diagram illustrating dedicated hardware for implementing the functions of the master device, the slave device, the mobile terminal, the base station, the small base station, and the mobile station according to the first to sixth embodiments; and

FIG. 18 is a diagram illustrating a control circuit for implementing the functions of the master device, the slave device, the mobile terminal, the base station, the small base station, and the mobile station according to the first to sixth embodiments.

### DETAILED DESCRIPTION OF THE PREFERRED EMBODIMENTS

Hereinafter, a fixed device, a position estimation system, a control circuit, a storage medium, a position estimation method, and mobile device according to embodiments of the present disclosure will be described in detail with reference to the drawings. Note that the technical scope of the present disclosure is not limited by the following embodiments.

### First Embodiment

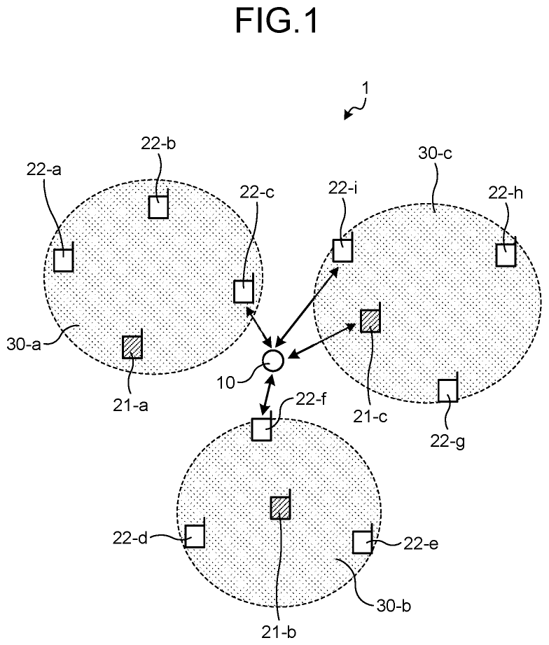

FIG. 1 is a diagram illustrating a configuration of a position estimation system 1 according to the first embodiment. The position estimation system 1 includes a plurality of master devices 21-a to 21-c, a plurality of slave devices 22-a to 22-i, and a mobile terminal 10. Hereinafter, components having similar functions are distinguished from each other by being denoted by a common number with a hyphen and an alphabet letter. In cases where components having similar functions need not be distinguished from each other, these are denoted by only a common number. For example, in cases where the master devices 21-a to 21-c need not be distinguished from each other, these are simply referred to as the master devices 21.

Each of the plurality of master devices 21-a to 21-c and the plurality of slave devices 22-a to 22-i is a fixed device fixed to the ground. Hereinafter, in cases where the master device 21 and the slave device 22 need not be distinguished from each other, these are referred to as fixed devices. An area 30 is formed for a plurality of fixed devices, and the fixed devices belong to any of the plurality of areas 30-a to 30-c. One master device 21 and the slave devices 22 subordinate to the master device 21 belong to each of the plurality of areas 30. Specifically, the master device 21-a and the slave devices 22-a to 22-c belong to the area 30-a. The master device 21-b and the slave devices 22-d to 22-f belong to the area 30-b. The master device 21-c and the slave devices 22-g to 22-i belong to the area 30-c. In this case, each of the areas 30-a to 30-c may be disposed to geographically overlap with each of the other areas 30.

The master device 21 transmits a notification signal as a representative of the area 30 to which the master device 21 belongs. The notification signal transmitted by the master device 21 includes the position information and the device identifier of the master device 21 and the position information and the device identifier of the slave devices 22 which are the other fixed devices belonging to the same area 30. Specifically, the master device 21-a transmits a notification signal including the position information and the device identifier of the master device 21-a and the position information and the device identifier of each of the slave devices 22-a to 22-c. The master device 21-b transmits a notification signal including the position information and the device identifier of the master device 21-b and the position information and the device identifier of the slave devices 22-d to 22-f. The master device 21-c transmits a notification signal including the position information and the device identifier of the master device 21-c and the position information and the device identifier of the slave devices 22-g to 22-i.

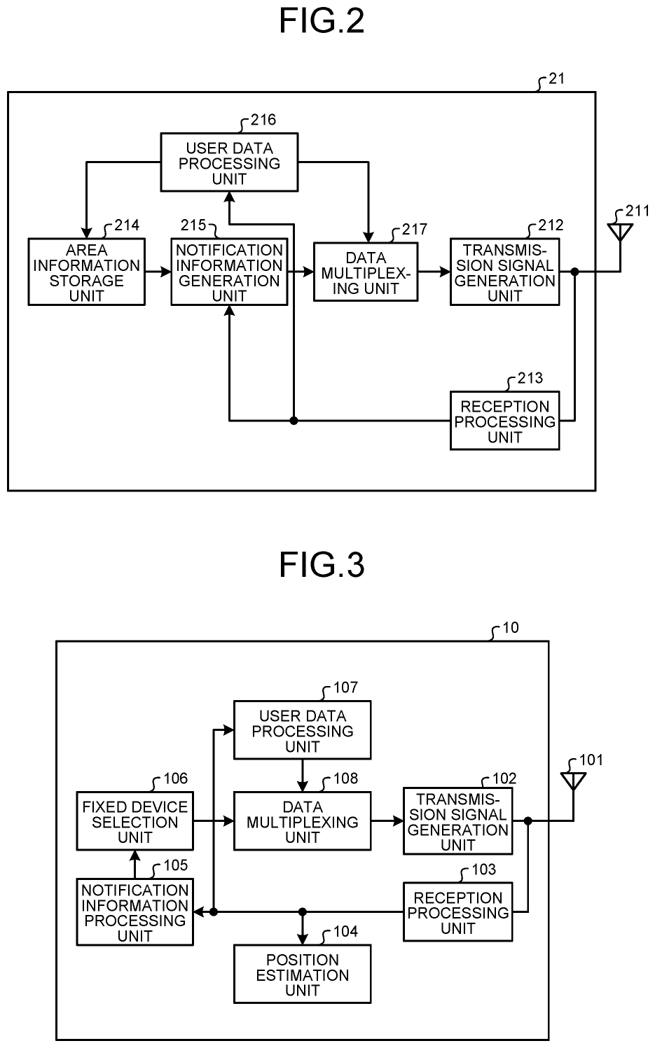

FIG. 2 is a diagram illustrating a functional configuration of the master device 21 illustrated in FIG. 1. The master device 21 includes a communication unit 211, a transmission signal generation unit 212, a reception processing unit 213, an area information storage unit 214, a notification information generation unit 215, a user data processing unit 216, and a data multiplexing unit 217. Note that FIG. 2 illustrates only the functional configuration required for explaining the functions of the master device 21 according to the first embodiment, and the master device 21 may have functions other than those illustrated in FIG. 2.

The communication unit 211 is an antenna capable of transmitting and receiving signals of UWB communication, and executes communication with the mobile terminal 10 and the slave device 22. The communication unit 211 can transmit and receive signals for use in positioning of the mobile terminal 10 to and from the mobile terminal 10. The signals for use in positioning of the mobile terminal 10 are, for example, notification signals. The communication unit 211 transmits a notification signal to the mobile terminal 10 at a timing different from the timing at which the master devices 21 in the other areas 30 transmit notification signals, so as to avoid collision with the notification signals transmitted from the other areas 30. For example, by determining the timing of notification signal transmission in advance for each area 30 in a time division manner, the communication unit 211 can transmit a notification signal at a timing different from the timing of notification signal transmission from the other areas 30.

The transmission signal generation unit 212 generates a transmission signal to be transmitted from the communication unit 211 to the mobile terminal 10. The transmission signal is a notification signal, a signal for use in distance measurement, or the like. The transmission signal generation unit 212 generates a transmission signal including the transmission data output from the data multiplexing unit 217. The reception processing unit 213 demodulates data from the signal received by the communication unit 211, and estimates the reception timing of the received signal.

The area information storage unit 214 stores area information including the area identifier for identifying the area 30 to which the master device 21 belongs, the device identifier and the position information of the master device 21, and the device identifier and the position information of the slave device 22 located in the area 30 to which the master device 21 belongs. Based on the area information stored in the area information storage unit 214, the notification information generation unit 215 generates notification information that the master device 21 transmits as a representative of the area 30. The notification information generated by the notification information generation unit 215 includes the device identifier and the position information of the master device 21, and also includes the device identifier and the position information of the slave devices 22 belonging to the same area 30 as the master device 21. In addition, the notification information generation unit 215 may generate notification information including information for use in position estimation, such as preamble code and communication speed. The notification information generation unit 215 outputs the generated notification information to the data multiplexing unit 217.

The user data processing unit 216 processes the user data included in the data demodulated by the reception processing unit 213, and generates the user data to be transmitted next. If area information is included in the data demodulated by the reception processing unit 213, the user data processing unit 216 updates the area information stored in the area information storage unit 214. Upon generating the user data to be transmitted next, the user data processing unit 216 outputs the generated user data to the data multiplexing unit 217.

The data multiplexing unit 217 multiplexes the notification information output from the notification information generation unit 215 and the user data output from the user data processing unit 216. The data multiplexing unit 217 outputs the transmission data, which is the multiplexed data, to the transmission signal generation unit 212.

FIG. 3 is a diagram illustrating a functional configuration of the mobile terminal 10 illustrated in FIG. 1. The mobile terminal 10 is an example of a mobile device. The mobile terminal 10 includes a communication unit 101, a transmission signal generation unit 102, a reception processing unit 103, a position estimation unit 104, a notification information processing unit 105, a fixed device selection unit 106, a user data processing unit 107, and a data multiplexing unit 108. Note that FIG. 3 illustrates only the functional configuration required for explaining the functions of the mobile terminal 10 according to the first embodiment, and the mobile terminal 10 may have functions other than those illustrated in FIG. 3.

The communication unit 101 is an antenna capable of executing UWB communication, and executes communication with the master device 21 and the slave device 22. The communication unit 101 can transmit and receive signals for use in positioning to and from the master device 21 and the slave device 22. The communication unit 101 can execute communication regardless of the area 30 to which the communication partner belongs. For example, as illustrated in FIG. 1, the communication unit 101 can communicate with the slave device 22-c belonging to the area 30-a, the slave device 22-f belonging to the area 30-b, and the master device 21-c and the slave device 22-i belonging to the area 30-c. The communication unit 101 transmits the transmission signal output from the transmission signal generation unit 102 to the communication partner, and outputs the reception signal received from the communication partner to the reception processing unit 103.

The transmission signal generation unit 102 generates a transmission signal including the transmission data output from the data multiplexing unit 108. The transmission signal generation unit 102 can transmit the generated transmission signal from the communication unit 101. The reception processing unit 103 demodulates reception data from the reception signal output from the communication unit 101, and estimates the timing of reception of the reception signal. The reception processing unit 103 outputs the demodulated reception data to the position estimation unit 104, the notification information processing unit 105, and the user data processing unit 107, and outputs the estimated reception timing to the position estimation unit 104.

The position estimation unit 104 measures the distance from each of a plurality of fixed devices selected based on the notification information included in the reception data, and estimates the position of the mobile terminal 10 based on the results of distance measurement and the position information of the fixed devices included in the notification information. Specifically, the position estimation unit 104 calculates the propagation time taken for communication from the transmission and reception timings of signals to and from a selected fixed device, and estimates the distance from the fixed device. The position estimation unit 104 can estimate the position of the mobile terminal 10 by using the results of measurement of the distance from three or more fixed devices.

The notification information processing unit 105 extracts the device identifier and the position information of the fixed devices in the area 30 where the master device 21 exists from the notification information included in the reception data, and creates a database of the extracted information. Using the database of information created by the notification information processing unit 105, the fixed device selection unit 106 selects the fixed devices to be used for position estimation from among the plurality of fixed devices indicated by the notification information, and generates data for use in distance measurement. The fixed device selection unit 106 outputs the data for use in distance measurement to the data multiplexing unit 108. The user data processing unit 107 generates the user data to be transmitted, and processes the user data included in the reception data. The user data processing unit 107 outputs to the data multiplexing unit 108 the user data to be transmitted. The data multiplexing unit 108 multiplexes the data for use in distance measurement output by the fixed device selection unit 106 and the user data output by the user data processing unit 107. The data multiplexing unit 108 outputs the transmission data, which is the multiplexed data, to the transmission signal generation unit 102.

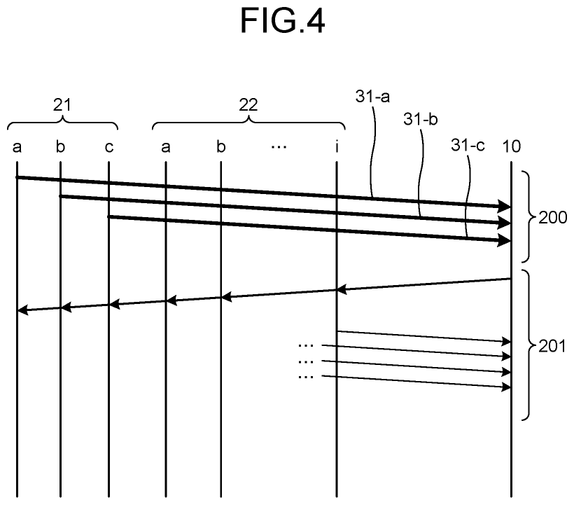

FIG. 4 is a sequence diagram for explaining a communication procedure in the position estimation system 1 illustrated in FIG. 1. First, the master devices 21-a to 21-c respectively transmit notification signals 31-a to 31-c including notification information in a time division manner. A period for use in transmitting the notification signal 31 is referred to as a notification signal transmission time 200. For example, in the example of FIG. 4, the master device 21-a transmits the notification signal 31-a, the master device 21-b subsequently transmits the notification signal 31-b, and the master device 21-c transmits the notification signal 31-c. In addition to the device identifier and the position information of the master device 21, the notification signal 31 includes the device identifier and the position information of the slave device 22 in the area 30 to which the master device 21 belongs. In addition, the notification signal 31 may further include data for use in positioning, such as preamble code and communication speed. In addition, all the position information may be absolute position information, or the position information of some fixed devices may be relative position information. For example, the notification signal 31 may include the absolute position information of the master device 21 and the relative position information of the slave device 22 with respect to the master device 21.

Upon receiving the notification signals 31-a to 31-c, the mobile terminal 10 retrieves the notification information included in each of the notification signals 31-a to 31-c. The mobile terminal 10 selects the fixed devices to be used for position estimation during a position estimation execution time 201 based on the retrieved notification information, transmits and receives data for use in distance measurement to and from the selected fixed devices, and estimates the position of the mobile terminal 10. In the first embodiment, the mobile terminal 10 selects the master device 21-c and the slave devices 22-c, 22-f, and 22-i. For example, the mobile terminal 10 may select a plurality of fixed devices in order of proximity from the mobile terminal 10 (namely in the ascending order of distance to the mobile terminal 10), or may divide using the mobile terminal 10 as a center into four quadrants and select one fixed device from each quadrant. Alternatively, the mobile terminal 10 may select fixed devices separated from each other by a predetermined distance or more. Based on a certain rule, fixed devices are selected.

Although FIG. 4 depicts only one notification signal transmission time 200, the notification signal transmission times 200 are provided periodically. Although FIG. 4 also depicts only one position estimation execution time 201, a plurality of position estimation execution times 201 are provided between the notification signal transmission time 200 and the notification signal transmission time 200 in consideration of an environment in which a plurality of mobile terminals 10 exist.

As described above, the master device 21 according to the first embodiment generates notification information including the position information of a plurality of fixed devices installed in the area 30, and transmits the notification information to the mobile terminal 10. This configuration allows the mobile terminal 10 to obtain the position information of the slave device 22 without notification of position information from the slave device 22 to the mobile terminal 10, so that the notification signal transmission time 200 can be shortened as compared with the case where all the fixed devices transmit notification signals. Therefore, it is possible to obtain a fixed device with which the frequency of implementation and accuracy of position estimation at the mobile terminal 10 can be maintained even in a case where the number of fixed devices increases.

### Second Embodiment

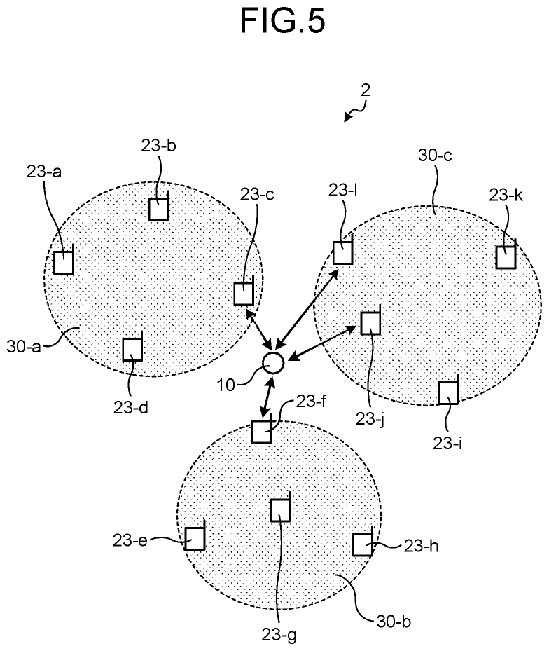

FIG. 5 is a diagram illustrating a configuration of a position estimation system 2 according to the second embodiment. The position estimation system 2 includes a plurality of fixed devices 23-a to 23-l and the mobile terminal 10. The area 30 is formed for a plurality of fixed devices 23, and each of the fixed devices 23-a to 23-l belongs to any of the plurality of areas 30-a to 30-c. Specifically, the fixed devices 23-a to 23-d belong to the area 30-a, the fixed devices 23-e to 23-h belong to the area 30-b, and the fixed devices 23-i to 23-l belong to the area 30-c.

In the first embodiment, the master device 21 that transmits the notification signal as a representative of the area 30 is determined in advance. In contrast, in the second embodiment, a plurality of fixed devices 23 can all operate as the master device 21 or as the slave device 22.

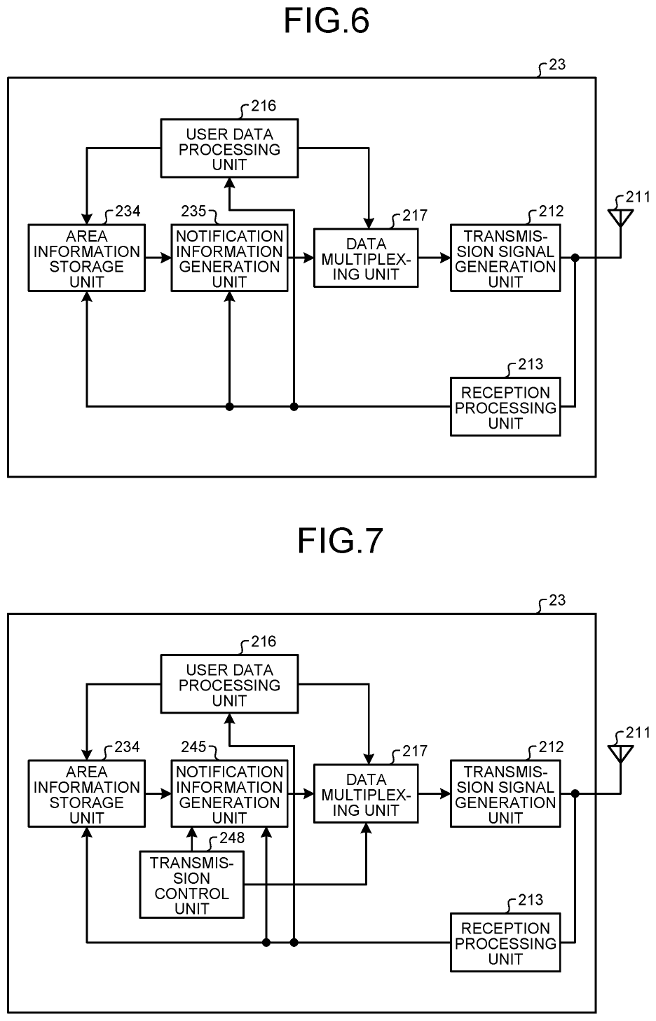

FIG. 6 is a diagram illustrating a functional configuration of the fixed device 23 illustrated in FIG. 5. The fixed device 23 includes the communication unit 211, the transmission signal generation unit 212, the reception processing unit 213, an area information storage unit 234, a notification information generation unit 235, the user data processing unit 216, and the data multiplexing unit 217. Note that FIG. 6 illustrates only the functional configuration required for explaining the functions of the fixed device 23 according to the second embodiment, and the fixed device 23 may have functions other than those illustrated in FIG. 6.

The communication unit 211 is an antenna capable of executing UWB communication, and executes communication with the mobile terminal 10 and other fixed devices 23. The communication unit 211 can transmit and receive signals for use in positioning of the mobile terminal 10 to and from the mobile terminal 10. The signals for use in positioning of the mobile terminal 10 are, for example, notification signals. The communication unit 211 transmits a notification signal to the mobile terminal 10 at a timing different from the timing of notification signal transmission from the other areas 30, so as to avoid collision with the notification signals transmitted from the other areas 30.

The transmission signal generation unit 212 generates a transmission signal to be transmitted from the communication unit 211 to the mobile terminal 10. The transmission signal is a notification signal, a signal for use in distance measurement, or the like. The transmission signal generation unit 212 generates a transmission signal including the transmission data output from the data multiplexing unit 217. The reception processing unit 213 demodulates reception data from the signal received by the communication unit 211, and estimates the reception timing of the received signal.

The area information storage unit 234 stores area information including the area identifier for identifying the area 30 to which this fixed device 23 belongs, the device identifier and the position information of the fixed device 23 located in the area 30 to which this fixed device 23 belongs, and the device identifier indicating the current master device 21. The notification information generation unit 235 determines whether this fixed device 23 is the master device 21 or the slave device 22 based on the area information stored in the area information storage unit 234. Specifically, if the device identifier indicating the current master device 21 matches the device identifier indicating this fixed device 23, the notification information generation unit 235 determines that this fixed device 23 is the master device 21, and if not, determines that this fixed device 23 is the slave device 22. The notification information generation unit 235 generates notification information if this fixed device 23 is the master device 21. The notification information generation unit 235 does not generate notification information if this fixed device 23 is the slave device 22. The notification information generated by the notification information generation unit 235 can include the device identifier and the position information of all the fixed devices 23 belonging to the area 30 to which this fixed device 23 belongs. The notification information generation unit 235 outputs the generated notification information to the data multiplexing unit 217.

The user data processing unit 216 processes the user data included in the data demodulated by the reception processing unit 213, and generates the user data to be transmitted next. If area information is included in the data demodulated by the reception processing unit 213, the user data processing unit 216 updates the area information stored in the area information storage unit 234. Upon generating the user data to be transmitted next, the user data processing unit 216 outputs the generated user data to the data multiplexing unit 217.

The data multiplexing unit 217 multiplexes the notification information output from the notification information generation unit 235 and the user data output from the user data processing unit 216. The data multiplexing unit 217 outputs the transmission data, which is the multiplexed data, to the transmission signal generation unit 212.

Note that the mobile terminal 10 illustrated in FIG. 5 has the configuration illustrated in FIG. 3, and each of the plurality of fixed devices 23 functions as the master device 21 or the slave device 22, whereby the position estimation system 2 executes the operation illustrated in FIG. 4. The operation of the position estimation system 2 is similar to that of the position estimation system 1 according to the first embodiment except that the fixed device 23 functioning as the master device 21 can be changed.

As described above, the fixed device 23 according to the second embodiment stores area information including the device identifier indicating the master device 21, and determines whether the fixed device 23 is the master device 21 or the slave device 22 based on the area information. The fixed device 23 generates notification information in response to determining that the fixed device 23 is the master device 21, and does not generate notification information in response to determining that the fixed device 23 is the slave device 22. This configuration allows all the plurality of fixed devices 23 included in the position estimation system 2 to function as the master device 21, and allows the fixed device 23 functioning as the master device 21 to be easily changed according to environmental changes in the position estimation system 2 or the like. Even when the master device 21 is malfunctioning or the communication environment between the master device 21 and the mobile terminal 10 is poor, the position estimation can be continued by changing the fixed device 23 functioning as the master device 21.

### Third Embodiment

The configuration of a position estimation system 3 (not illustrated) according to the third embodiment is similar to that in the second embodiment illustrated in FIG. 5. The functional configuration of the mobile terminal 10 is similar to that in the first and second embodiments, and the functional configuration of the fixed device 23 is similar to that in the second embodiment. In the second embodiment, the fixed device 23 functioning as the master device 21 is fixed unless the area information is manually rewritten. In contrast, in the third embodiment, the fixed device 23 functioning as the master device 21 is automatically changed.

For example, in response to the master device 21 transmitting notification information a predetermined number of times, the device identifier indicating the master device 21 included in the area information is changed to a device identifier indicating another fixed device 23 in the area 30, and the other fixed devices 23 are notified to change the area information, whereby the fixed device 23 functioning as the master device 21 can be changed. In addition, whether to change the fixed device 23 functioning as the master device 21 may be determined based on the position information of the mobile terminal 10. In the event that the master device 21 cannot secure the quality of communication with the mobile terminal 10, the fixed device 23 functioning as the master device 21 can be changed to another fixed device 23 in the area 30.

As described above, in the position estimation system 3 according to the third embodiment, the fixed device 23 functioning as the master device 21 is automatically changed. Therefore, even when the master device 21 is malfunctioning or the communication environment between the master device 21 and the mobile terminal 10 is poor, the quality of communication between the mobile terminal 10 and the master device 21 is improved over time, so that highly accurate position estimation can be resumed.

### Fourth Embodiment

FIG. 7 is a diagram illustrating a functional configuration of the fixed device 23 according to the fourth embodiment. The configuration of a position estimation system 4 (not illustrated) according to the fourth embodiment is similar to the system configuration in the second embodiment illustrated in FIG. 5, and is different from the second embodiment in that the fixed device 23 having the functional configuration illustrated in FIG. 7 is provided instead of the fixed device 23 having the functional configuration illustrated in FIG. 6. The fixed device 23 includes the communication unit 211, the transmission signal generation unit 212, the reception processing unit 213, the area information storage unit 234, a notification information generation unit 245, the user data processing unit 216, the data multiplexing unit 217, and a transmission control unit 248. Note that FIG. 7 illustrates only the functional configuration required for explaining the functions of the fixed device 23 according to the fourth embodiment, and the fixed device 23 may have functions other than those illustrated in FIG. 7.

The communication unit 211 is an antenna capable of executing UWB communication, and executes communication with the mobile terminal 10 and other fixed devices 23. The communication unit 211 can transmit and receive signals for use in positioning of the mobile terminal 10 to and from the mobile terminal 10. The signals for use in positioning of the mobile terminal 10 are, for example, notification signals. The communication unit 211 transmits a notification signal to the mobile terminal 10 at a timing different from the timing of notification signal transmission from the other areas 30, so as to avoid collision with the notification signals transmitted from the other areas 30.

The transmission signal generation unit 212 generates a transmission signal to be transmitted from the communication unit 211 to the mobile terminal 10. The transmission signal is a notification signal, a signal for use in distance measurement, or the like. The transmission signal generation unit 212 generates a transmission signal including the transmission data output from the data multiplexing unit 217. The reception processing unit 213 demodulates reception data from the signal received by the communication unit 211, and estimates the reception timing of the received signal.

The area information storage unit 234 stores area information including the area identifier for identifying the area 30 to which this fixed device 23 belongs, the device identifier and the position information of the fixed device 23 located in the area 30 to which this fixed device 23 belongs, and the device identifier indicating the current master device 21.

The transmission control unit 248 determines the type of notification information to be transmitted by the fixed device 23, and provides an instruction on the determined type of notification information to the notification information generation unit 245. Specifically, even in a case where it is determined that the fixed device 23 functions as the slave device 22, the transmission control unit 248 causes the notification information generation unit 245 to generate individual notification information including one device identifier and one piece of position information at a frequency of generation lower than the frequency of transmission of notification signals by the master device 21. For example, the slave device 22 transmits individual notification information every time the master device 21 transmits notification information a predetermined number of times.

The notification information generation unit 245 generates notification information in accordance with the instruction from the transmission control unit 248. The notification information generation unit 245 determines whether the fixed device 23 is the master device 21 or the slave device 22 based on the area information stored in the area information storage unit 234. Specifically, if the device identifier indicating the current master device 21 matches the device identifier indicating this fixed device 23 itself, the notification information generation unit 245 determines that this fixed device 23 is the master device 21, and if not, determines that this fixed device 23 is the slave device 22. If this fixed device 23 is the master device 21, the notification information generation unit 245 periodically generates notification information including a plurality of device identifiers and position information. If this fixed device 23 is the slave device 22, the notification information generation unit 245 does not generate notification information including a plurality of device identifiers and position information, but generates individual notification information in accordance with the instruction from the transmission control unit 248. The notification information generation unit 245 outputs the generated notification information or individual notification information to the data multiplexing unit 217.

The user data processing unit 216 processes the user data included in the data demodulated by the reception processing unit 213, and generates the user data to be transmitted next. If area information is included in the data demodulated by the reception processing unit 213, the user data processing unit 216 updates the area information stored in the area information storage unit 234. Upon generating the user data to be transmitted next, the user data processing unit 216 outputs the generated user data to the data multiplexing unit 217.

The data multiplexing unit 217 multiplexes the notification information or individual notification information output from the notification information generation unit 245 and the user data output from the user data processing unit 216. The data multiplexing unit 217 outputs the transmission data, which is the multiplexed data, to the transmission signal generation unit 212.

As described above, in the position estimation system 4 according to the fourth embodiment, as in the second and third embodiments, the fixed device 23 periodically transmits notification information in response to a determination that the fixed device 23 is the master device 21, and does not transmit notification information in response to a determination that the fixed device 23 is the slave device 22. In the position estimation system 4, however, even in a case where it is determined that the fixed device 23 is the slave device 22, notification signals including individual notification information are transmitted at a frequency of transmission lower than the frequency of notification signals the master device 21 transmits. As a result, all the fixed devices 23 in the area 30 provide notification of position information at a frequency of transmission lower than the frequency at which the master device 21 transmits notification signals. The position estimation system 4 with this configuration can shorten the notification signal transmission time 200, and also increase the probability that the mobile terminal 10 can grasp the position information of the fixed device 23 suitable for use in position estimation regardless of the position of the mobile terminal 10.

### Fifth Embodiment

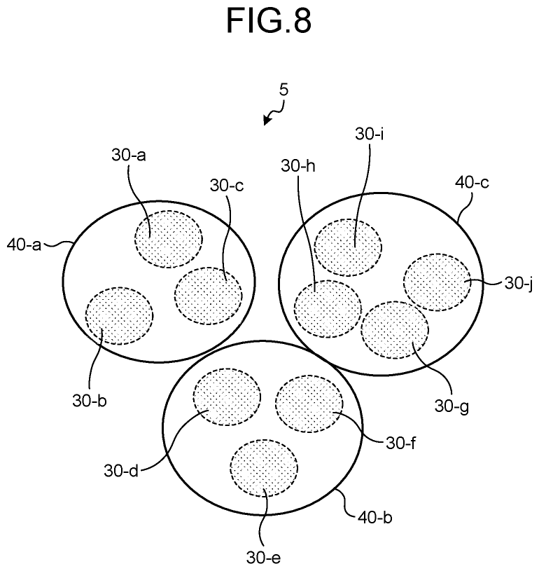

FIG. 8 is a diagram illustrating a configuration of a position estimation system 5 according to the fifth embodiment. The position estimation system 5 forms a plurality of areas 30-a to 30-j and extended areas 40-a to 40-c including the plurality of areas 30. Specifically, the extended area 40-a includes the areas 30-a to 30-c, the extended area 40-b includes the areas 30-d to 30-f, and the extended area 40-c includes the areas 30-g to 30-j. In this case, the extended areas 40 may geographically overlap with each other. In the extended area 40, each area 30 transmits a notification signal and performs position estimation as in the second to fourth embodiments. In this case, the plurality of extended areas 40 use different preamble spreading methods.

As described above, in the position estimation system 5 according to the fifth embodiment, different preambles are used for different extended areas 40, so that the position estimation processing that is executed for each extended area 40 can be performed in parallel, and the frequency of distance measurement can be improved.

### Sixth Embodiment

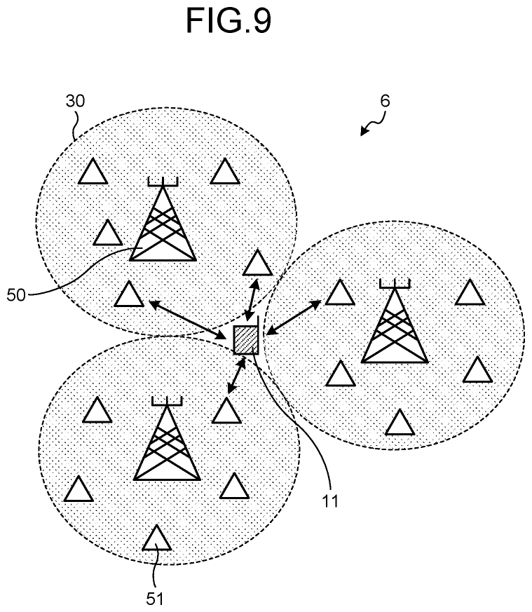

FIG. 9 is a diagram illustrating a configuration of a position estimation system 6 according to the sixth embodiment. The position estimation system 6 includes a plurality of areas 30, and each of the plurality of areas 30 is a wireless communication system including a base station 50 that includes the entire area 30 in its coverage, a plurality of small base stations 51 having a narrower coverage than the base station 50, and a mobile station 11. The base station 50 is an example of the master device 21, the small base station 51 is an example of the slave device 22, and the mobile station 11 is an example of a mobile device. The small base station 51 can be connected to the base station 50. In addition, the small base station 51 can perform what is called UWB communication with the mobile station 11. UWB communication is short-range, high-speed communication using high-frequency, ultra-wide band signals. The mobile station 11 can communicate with the base station 50 and the small base station 51.

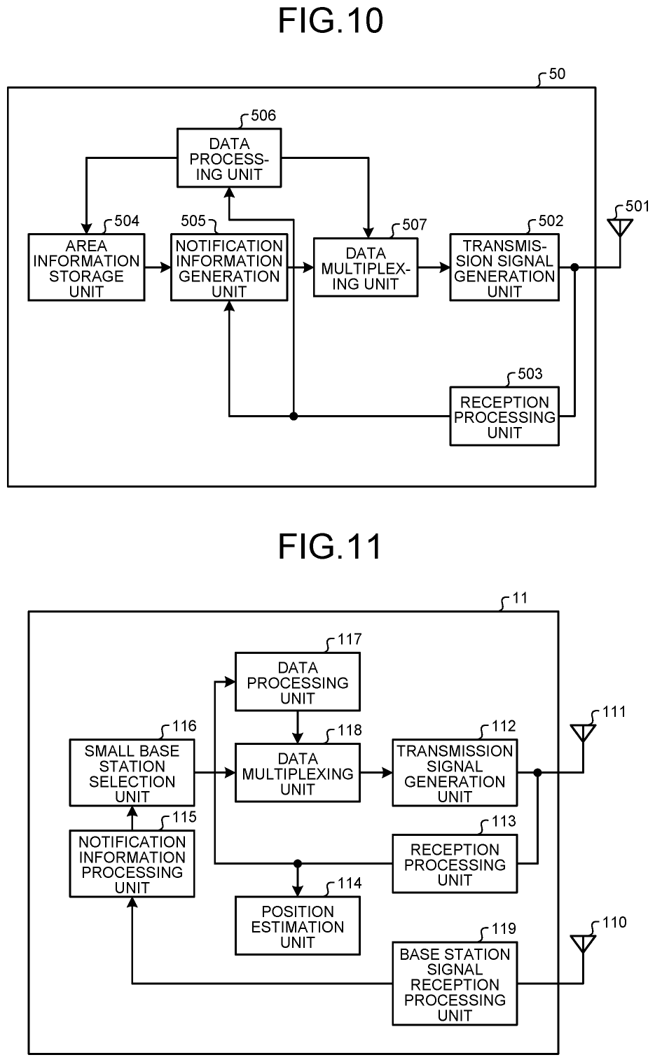

FIG. 10 is a diagram illustrating a functional configuration of the base station 50 illustrated in FIG. 9. The base station 50 includes a communication unit 501, a transmission signal generation unit 502, a reception processing unit 503, an area information storage unit 504, a notification information generation unit 505, a data processing unit 506, and a data multiplexing unit 507. Note that FIG. 10 illustrates only the functional configuration required for explaining the functions of the base station 50 according to the sixth embodiment, and the base station 50 may have functions other than those illustrated in FIG. 10.

The communication unit 501 is an antenna for executing communication with the mobile station 11 and the small base station 51. The communication unit 501 can transmit and receive signals for use in positioning of the mobile station 11 to and from the mobile station 11. The signals for use in positioning of the mobile station 11 are, for example, notification signals. The communication unit 501 transmits a notification signal to the mobile station 11 at a timing different from the timing of notification signal transmission from the other areas 30, so as to avoid collision with the notification signals transmitted from the other areas 30.

The transmission signal generation unit 502 generates a transmission signal to be transmitted from the communication unit 501 to the mobile station 11. The transmission signal is a notification signal, a signal for use in distance measurement, or the like. The transmission signal generation unit 502 generates a transmission signal including the transmission data output from the data multiplexing unit 507. The reception processing unit 503 demodulates data from the signal received by the communication unit 501, and estimates the reception timing of the received signal.

The area information storage unit 504 stores area information including the device identifier and the position information of the small base station 51 located in the area 30 to which the small base station 51 belongs. Based on the area information stored in the area information storage unit 504, the notification information generation unit 505 generates notification information that the base station 50 transmits as a representative of the area 30. The notification information generated by the notification information generation unit 505 includes the device identifier and the position information of a plurality of small base stations 51 belonging to the same area 30 as the base station 50. Note that in the sixth embodiment, the mobile station 11 does not measure the distance from the base station 50 but measures the distance from the small base station 51; therefore, the notification information need not necessarily include the device identifier and the position information of the base station 50. The notification information generation unit 505 outputs the generated notification information to the data multiplexing unit 507.

The data processing unit 506 processes the user data included in the data demodulated by the reception processing unit 503, and generates the data to be transmitted next. The data to be transmitted next includes, for example, user data, control data, and the like. If area information is included in the data demodulated by the reception processing unit 503, the data processing unit 506 updates the area information stored in the area information storage unit 504. Upon generating the data to be transmitted next, the data processing unit 506 outputs the generated data to the data multiplexing unit 507.

The data multiplexing unit 507 multiplexes the notification information output from the notification information generation unit 505 and the data output from the data processing unit 506. The data multiplexing unit 507 outputs the transmission data, which is the multiplexed data, to the transmission signal generation unit 502.

FIG. 11 is a diagram illustrating a functional configuration of the mobile station 11 illustrated in FIG. 9. The mobile station 11 includes a base station communication unit 110, a communication unit 111, a transmission signal generation unit 112, a reception processing unit 113, a position estimation unit 114, a notification information processing unit 115, a small base station selection unit 116, a data processing unit 117, a data multiplexing unit 118, and a base station signal reception processing unit 119. Note that FIG. 11 illustrates only the functional configuration required for explaining the functions of the mobile station 11 according to the sixth embodiment, and the mobile station 11 may have functions other than those illustrated in FIG. 11.

The base station communication unit 110 is an antenna for communicating with the base station 50. The base station signal reception processing unit 119 processes the signal received by the base station communication unit 110 from the base station 50. The base station signal reception processing unit 119 demodulates reception data from the reception signal, and outputs the reception data to the notification information processing unit 115.

The communication unit 111 is an antenna capable of executing wide band communication, and performs wide band communication and distance measurement with the small base station 51. The communication unit 111 transmits the transmission signal output from the transmission signal generation unit 112 to the communication partner, and outputs the reception signal received from the communication partner to the reception processing unit 113.

The transmission signal generation unit 112 generates a transmission signal including the transmission data output from the data multiplexing unit 118. The transmission signal generation unit 112 can transmit the generated transmission signal from the communication unit 111. The reception processing unit 113 demodulates reception data from the reception signal output from the communication unit 111, and estimates the timing of reception of the reception signal. The reception processing unit 113 outputs the demodulated reception data to the position estimation unit 114 and the data processing unit 117, and outputs the estimated reception timing to the position estimation unit 114.

The position estimation unit 114 measures the distance from each of a plurality of small base stations 51 selected based on the notification information included in the reception data from the base station 50, and estimates the position of the mobile station 11 based on the results of distance measurement and the position information of the small base stations 51 included in the notification information. Specifically, the position estimation unit 114 calculates the propagation time taken for communication from the transmission and reception timings of signals to and from a selected small base station 51, and estimates the distance from the small base station 51. The position estimation unit 114 can estimate the position of the mobile station 11 by using the results of measurement of the distance from three or more small base stations 51.

The notification information processing unit 115 extracts the device identifier and the position information of the small base stations 51 in the area 30 where the base station 50 exists from the notification information included in the reception data from the base station 50, and creates a database of the extracted information. Using the database of information created by the notification information processing unit 115, the small base station selection unit 116 selects the small base stations 51 to be used for position estimation from among the plurality of small base stations 51 indicated by the notification information, and generates data for use in distance measurement. The small base station selection unit 116 outputs the data for use in distance measurement to the data multiplexing unit 118. The data processing unit 117 generates the user data to be transmitted, and processes the user data included in the reception data. The data processing unit 117 outputs to the data multiplexing unit 118 the user data to be transmitted. The data multiplexing unit 118 multiplexes the data for use in distance measurement output by the small base station selection unit 116 and the user data output by the data processing unit 117. The data multiplexing unit 118 outputs the transmission data, which is the multiplexed data, to the transmission signal generation unit 112.

As described above, according to the sixth embodiment, the base station 50 generates notification information including the device identifier and the position information of a plurality of small base stations 51, and the mobile station 11 performs distance measurement through wide band communication with the small base stations selected from among the plurality of small base stations 51 indicated by the notification information, and estimates the position of the mobile station 11 using the results of distance measurement. As a result, in the case of using the small base station 51 that uses ultra-wide band signals also in the wireless communication system, the mobile station 11 can be notified of the position information of the small base station 51 without transmission of notification signals from the small base station 51 itself. Therefore, the notification signal transmission time 200 can be shortened as compared with the case where all the fixed devices, that is, all the base stations 50 and the small base stations 51, transmit notification signals. Therefore, the frequency and accuracy of position estimation at the mobile station 11 can be maintained even in a case where the number of fixed devices, namely the number of small base stations 51, increases.

### Seventh Embodiment

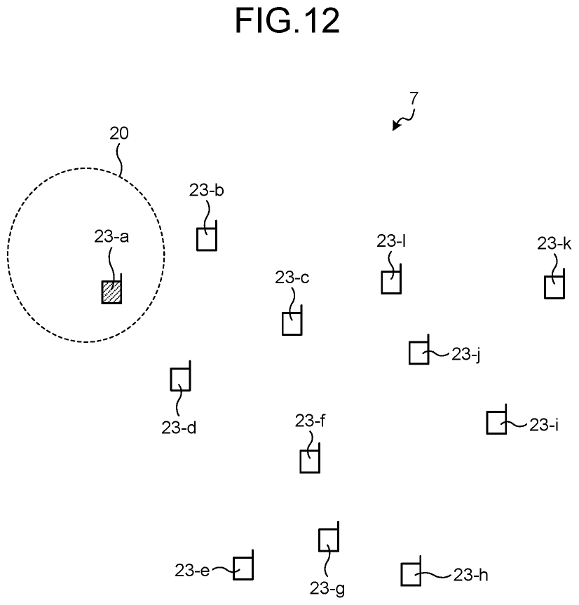

FIG. 12 is a diagram illustrating a configuration of a position estimation system 7 according to the seventh embodiment. The position estimation system 7 includes the plurality of fixed devices 23-a to 23-l. One of the plurality of fixed devices 23 is set as an administration terminal 20. In the example of FIG. 12, the fixed device 23-a is the administration terminal 20.

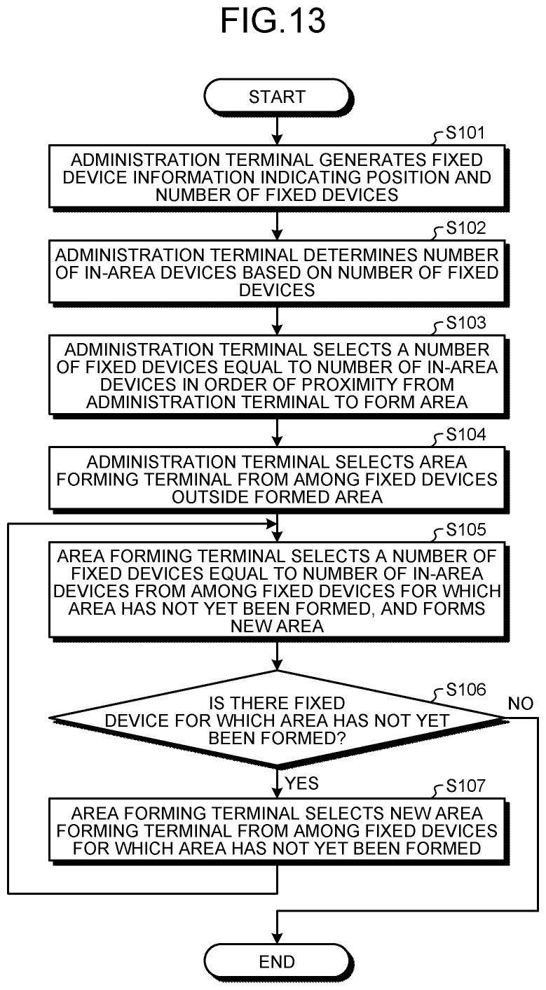

FIG. 13 is a flowchart for explaining a method with which the position estimation system 7 illustrated in FIG. 12 forms the areas 30. The fixed device 23-a, which is the administration terminal 20, causes measurement of the distance between a plurality of fixed devices 23 capable of communicating with each other, and generates fixed device information indicating the position and number of the plurality of fixed devices 23 (step S101).

Based on the number of fixed devices indicated by the fixed device information, the administration terminal 20 determines the number of in-area devices, i.e. the number of fixed devices 23 belonging to one area (step 3102). The administration terminal 20 selects a number of fixed devices 23 whose number is equal to the number of in-area devices in order of proximity from the administration terminal 20 (namely, in the ascending order of distance to the administration terminal 20) to form an area 30 (step S103).

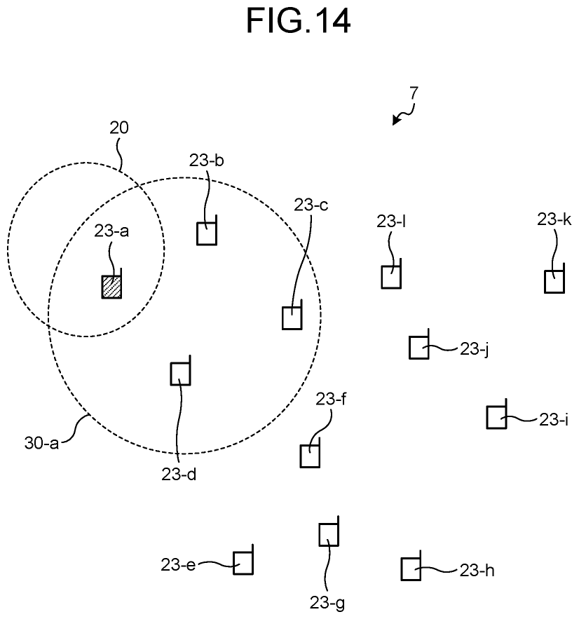

FIG. 14 is a diagram illustrating the position estimation system 7 after execution of step S103 in FIG. 13. The fixed device 23-a, which is the administration terminal 20, selects a number of fixed devices 23 equal to the number of in-area devices from among the fixed devices 23-a to 23-l in order of proximity from the fixed device 23-a. Here, given that the number of in-area devices is four, the fixed devices 23-a to 23-d are selected in order of proximity from the fixed device 23-a, and the area 30-a is formed.

Subsequently, the administration terminal 20 selects an area forming terminal 25 from among the fixed devices 23 outside the formed area 30 (step S104). For example, the fixed device 23-e can be the area forming terminal 25. The area forming terminal 25 selects a number of fixed devices 23 equal to the number of in-area devices from among the fixed devices 23 for which the area 30 has not yet been formed, and forms a new area 30 (step S105).

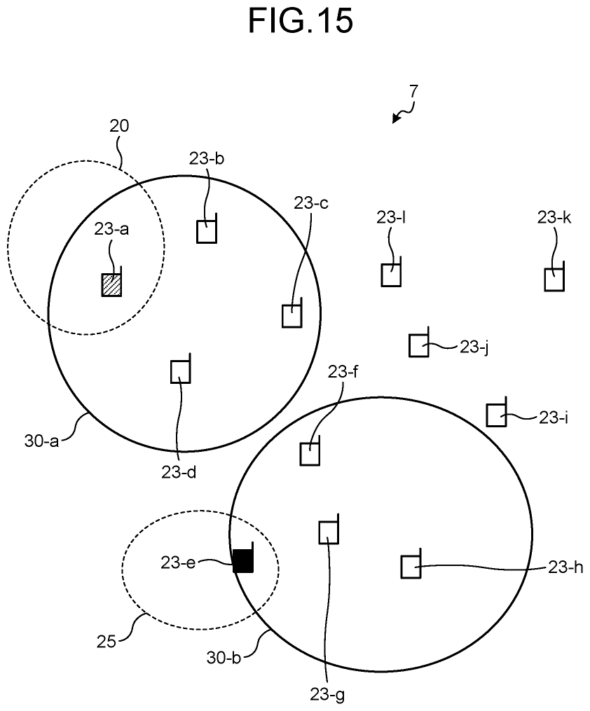

FIG. 15 is a diagram illustrating a first example of the position estimation system 7 after execution of step S105 in FIG. 13. The fixed device 23-e, which is the area forming terminal 25, selects, for example, four fixed devices 23-e to 23-h in order of proximity from the fixed device 23-e from among the fixed devices 23-e to 23-l for which the area 30 has not been formed at the time of selection as the area forming terminal 25, and forms a new area 30-b.

Subsequently, the area forming terminal 25 determines whether there is a fixed device 23 for which the area 30 has not yet been formed (step S106). In response to determining that there is a fixed device 23 for which the area 30 has not yet been formed (step S106: Yes), the area forming terminal 25 selects a new area forming terminal 25 from among the fixed devices 23 for which the area has not yet been formed (step S107). For example, the fixed device 23-i can be a new area forming terminal 25. After step S107 is executed, the procedure returns to step S105. In response to determining that there is no fixed device 23 for which the area has not yet been formed (step S106: No), the formation of the areas 30 ends.

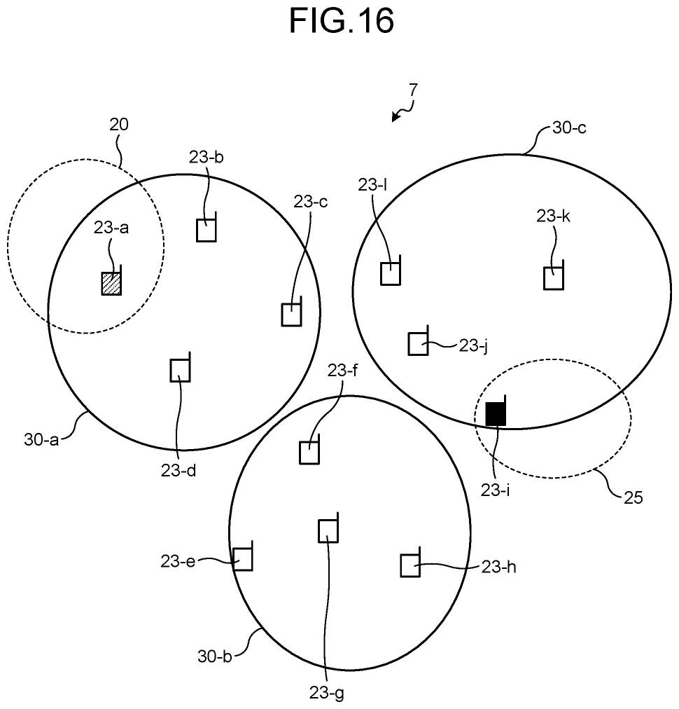

FIG. 16 is a diagram illustrating a second example of the position estimation system 7 after execution of step S105 in FIG. 13. FIG. 16 illustrates an example of the position estimation system 7 in which step S107 is executed and then step S105 is executed again. The fixed device 23-i, which is the area forming terminal 25, selects four fixed devices 23-i to 23-l from among the fixed devices 23-i to 23-l for which the area 30 has not yet been formed, and forms a new area 30-c. In the state illustrated in FIG. 16, there is no fixed device 23 for which the area has not yet been formed, and thus the formation of the areas 30 ends.

By performing the operation illustrated in FIG. 13, the selection of the area forming terminal 25 and the formation of a new area 30 are repeated until there is no fixed device 23 left for which the area 30 has not been formed. As a result, the areas 30 can be automatically formed. In addition, in the process of forming the area 30, the master device 21 may be designated. For example, the administration terminal 20 and the area forming terminal 25 may form the area 30, and also designate one fixed device 23 as the master device 21 in the formed area 30. The master device 21 can be the fixed device 23 closest to the center in the area 30.

As described above, according to the seventh embodiment, the areas 30 can be automatically formed without preliminarily forming the areas 30. After the formation of the areas 30, notification information including the position information of a plurality of fixed devices 23 can be transmitted to the mobile terminal 10 as in the first to sixth embodiments. Therefore, the fixed device 23 functioning as the slave device 22 does not need to notify the mobile terminal 10 of its position information, so that the notification signal transmission time 200 can be shortened as compared with the case where all the fixed devices 23 transmit notification signals. Therefore, the frequency and accuracy of position estimation at the mobile terminal 10 can be maintained even in a case where the number of fixed devices 23 increases.

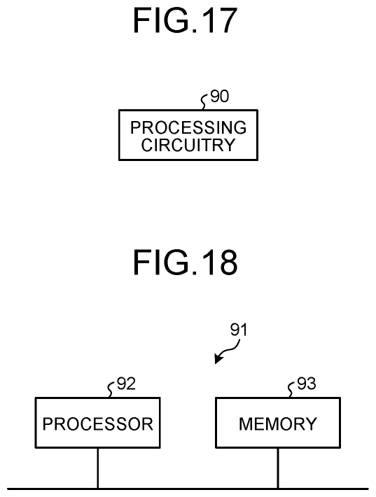

FIG. 17 is a diagram illustrating dedicated hardware for implementing the functions of the master device 21, the slave device 22, the mobile terminal 10, the base station 50, the small base station 51, and the mobile station 11 according to the first to sixth embodiments. Each function of the master device 21, the slave device 22, the mobile terminal 10, the base station 50, the small base station 51, and the mobile station 11 can be implemented by, for example, processing circuitry 90 which is dedicated hardware. The processing circuitry 90 is a single circuit, a composite circuit, a programmed processor, a parallel programmed processor, an application specific integrated circuit (ASIC), a field programmable gate array (FPGA), or a combination thereof.

FIG. 18 is a diagram illustrating a control circuit 91 for implementing the functions of the master device 21, the slave device 22, the mobile terminal 10, the base station 50, the small base station 51, and the mobile station 11 according to the first to sixth embodiments. The control circuit 91 includes a processor 92 and a memory 93.

The processor 92 is a central processing unit (CPU), and is also called an arithmetic device, a microprocessor, a microcomputer, a digital signal processor (DSP), or the like. Examples of the memory 93 include a non-volatile or volatile semiconductor memory, a magnetic disk, a flexible disk, an optical disc, a compact disc, a mini disc, a digital versatile disk (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

In the case where the control circuit 91 implements the functions of the master device 21, the slave device 22, the mobile terminal 10, the base station 50, the small base station 51, and the mobile station 11, the processor 92 reads and executes a program stored in the memory 93 corresponding to the processing in each component, thereby implementing the functions. This program may be provided by being stored in a storage medium, or may be provided via a communication path such as the Internet. The memory 93 is also used as a temporary memory for each process executed by the processor 92.

Note that the functions of the master device 21, the slave device 22, the mobile terminal 10, the base station 50, the small base station 51, and the mobile station 11 can also be implemented by combining the processing circuitry 90 which is dedicated hardware and the control circuit 91 using a CPU.

The fixed device according to the present disclosure can achieve the effect of maintaining the frequency of implementation and accuracy of position estimation at a mobile device even in a case where the number of fixed devices increases.

The configurations described in the above-mentioned embodiments indicate examples. The embodiments can be combined with another well-known technique and with each other, and some of the configurations can be omitted or changed in a range not departing from the gist.

What is claimed is:

1. A fixed device belonging to any of a plurality of areas, the fixed device comprising:
notification information generation circuitry to generate notification information including position information of a plurality of fixed devices installed in the area to which the fixed device belongs;
communication circuitry to transmit a notification signal including the notification information to a mobile device at a timing different from a timing of transmission of the notification signal from another area, the mobile device being configured to estimate a position based on the notification information; and
area information storage circuitry to store area information including a device identifier indicating a master device that generates the notification information as a representative of the area among the plurality of fixed devices installed in the area, wherein
in response to receiving a signal for use in distance measurement from the mobile device that has received the notification signal, the communication circuitry transmits a signal for use in distance measurement in the mobile device according to the signal, and
the notification information generation circuitry generates the notification information in response to determining that the fixed device is the master device based on the area information, and does not generate the notification information in response to determining that the fixed device is a slave device that is the fixed device different from the master device based on the area information.

2. The fixed device according to claim 1, wherein the master device changes the device identifier included in the area information every time the master device transmits the notification information a predetermined number of times.

3. The fixed device according to claim 1, wherein the master device changes the device identifier included in the area information based on position information of the mobile device.

4. The fixed device according to claim 1, further comprising
transmission control circuitry to, even in a case where it is determined that the fixed device is the slave device based on the area information, cause the notification information generation circuitry to generate individual notification information including one device identifier and one piece of position information at a frequency of generation lower than a frequency of transmission of the notification signal.

5. A position estimation system comprising:
the fixed device according to claim 1; and
a mobile device to estimate a position based on the notification information received from the fixed device.

6. The position estimation system according to claim 5, wherein
the plurality of areas form an extended area, and
the fixed devices and the mobile device use different preambles for different extended areas.

7. The position estimation system according to claim 5, wherein
the master device is a base station,
the slave device is a small base station to communicate using an ultra-wide band signal in a narrower coverage than the base station,
the mobile device is a mobile station to communicate with the small base station using the ultra-wide band signal,
the base station generates notification information including a device identifier and position information of a plurality of the small base stations, and
the mobile station estimates a position of the mobile station using a result of measurement of a distance from the small base station selected from among the plurality of small base stations.

8. The position estimation system according to claim 5, wherein
one of the plurality of fixed devices is set as an administration terminal,
the administration terminal causes measurement of a distance between the plurality of fixed devices capable of communicating with each other, and generates fixed device information indicating positions and number of the plurality of fixed devices capable of communicating with each other, and
the areas are formed based on the fixed device information in accordance with an instruction from the administration terminal.

9. The position estimation system according to claim 8, wherein
the administration terminal determines, based on the number of fixed devices indicated by the fixed device information, number of in-area devices that is number of the fixed devices belonging to one area, selects a number of fixed devices equal to the number of in-area devices in order of proximity from the administration terminal to form the area, and selects one area forming terminal from among the fixed devices outside the area formed,
the area forming terminal selects, from among the fixed devices for which an area has not yet been formed, a number of fixed devices equal to the number of in-area devices in order of proximity from the area forming terminal to form a new area, and newly selects the area forming terminal from among the fixed devices for which the area has not yet been formed, and
selection of the area forming terminal and formation of a new area are repeated until there is no fixed device left for which an area has not been formed.

10. A control circuit that controls a fixed device belonging to any of a plurality of areas, the control circuit causing the fixed device to execute:
determining, based on area information including a device identifier indicating a master device that generates notification information as a representative of the area among a plurality of fixed devices installed in the area, whether the fixed device to be controlled is the master device or a slave device that is the fixed device different from the master device;
generating, in response to determining that the fixed device to be controlled is the master device, the notification information including position information of the plurality of fixed devices installed in the area to which the fixed device belongs;
transmitting, in response to generating the notification information, a notification signal including the notification information to a mobile device at a timing different from a timing of transmission of the notification signal from another area, the mobile device being configured to estimate a position based on the notification information; and
transmitting, in response to receiving a signal for use in distance measurement from the mobile device that has received the notification signal, a signal for use in distance measurement in the mobile device according to the signal, wherein
the notification information is not generated in response to determining that the fixed device to be controlled is the slave device.

11. A storage medium storing a program for controlling a fixed device belonging to any of a plurality of areas, the program causing the fixed device to execute:
determining, based on area information including a device identifier indicating a master device that generates notification information as a representative of the area among a plurality of fixed devices installed in the area, whether the fixed device to be controlled is the master device or a slave device that is the fixed device different from the master device;
generating, in response to determining that the fixed device to be controlled is the master device, the notification information including position information of the plurality of fixed devices installed in the area to which the fixed device belongs;
transmitting, in response to generating the notification information, a notification signal including the notification information to a mobile device at a timing different from a timing of transmission of the notification signal from another area, the mobile device being configured to estimate a position based on the notification information; and
transmitting, in response to receiving a signal for use in distance measurement from the mobile device that has received the notification signal, a signal for use in distance measurement in the mobile device according to the signal, wherein
the notification information is not generated in response to determining that the fixed device to be controlled is the slave device.

12. A position estimation method comprising:
generating, by a master device that is one of a plurality of fixed devices belonging to any of a plurality of areas and is a representative of the area to which the master device belongs, notification information including position information of the plurality of fixed devices installed in the area to which the master device belongs;
transmitting, by the master device as a representative of the area to which the master device belongs, a notification signal including the notification information to a mobile device at a timing different from a timing of transmission of the notification signal from another area;
receiving, by the mobile device, a signal including the notification information;
selecting, by the mobile device, the fixed device for use in position estimation from among the plurality of fixed devices based on the notification information;
measuring, by the mobile device, a distance from the fixed device selected; and
estimating, by the mobile device, a position of the mobile device using a result of measurement of the distance and the position information included in the notification information.

13. A mobile device comprising:
communication circuitry to receive, from a master device that is one of a plurality of fixed devices belonging to any of a plurality of areas and is a representative of the area, a signal including notification information including position information of the plurality of fixed devices installed in the area;
fixed device selection circuitry to select the fixed device for use in position estimation from among the plurality of fixed devices based on the notification information; and
position estimation circuitry to measure a distance from the fixed device selected, and estimate a position of the mobile device using a result of measurement of the distance and the position information included in the notification information.

14. A control circuit that controls a mobile device, the control circuit causing the mobile device to execute:
receiving, from a master device that is one of a plurality of fixed devices belonging to any of a plurality of areas and is a representative of the area, a signal including notification information including position information of the plurality of fixed devices installed in the area;
selecting the fixed device for use in position estimation from among the plurality of fixed devices based on the notification information;
measuring a distance from the fixed device selected; and
estimating a position of the mobile device using a result of measurement of the distance and the position information included in the notification information.

15. A storage medium storing a program for controlling a mobile device, the program causing the mobile device to execute:
receiving, from a master device that is one of a plurality of fixed devices belonging to any of a plurality of areas and is a representative of the area, a signal including notification information including position information of the plurality of fixed devices installed in the area;
selecting the fixed device for use in position estimation from among the plurality of fixed devices based on the notification information;
measuring a distance from the fixed device selected; and
estimating a position of the mobile device using a result of measurement of the distance and the position information included in the notification information.
